(19) United States
(12) Patent Application Publication
(10) Pub. No.: US 2006/0290336 A1
(43) Pub. Date: Dec. 28, 2006

(54) Voltage regulator load compensator

(75) Inventor: Mel Bazes, Haifa (IL)

Correspondence Address: JUNG-HUA KUO;C/O PORTFOLIOIP, P. O. BOX 52050, MINNEAPOLIS, MN, 55402, US

(73) Assignee: Intel Corporation, Santa Clara, CA (US)

(21) Appl. No.: 11/168,097

(22) Filed: Jun. 28, 2005

(51) Int. Cl. G05F 3/04

(52) U.S. Cl. 323/312; 315/287

(57) ABSTRACT

One disclosed method involves suppressing ringing on a voltage regulator output by using a load compensator to monitor the output of the voltage regulator. If an output voltage is detected that is greater than a first predefined level, the output voltage is driven lower, and if an output voltage is detected that is less than a second predefined level, the output voltage is driven higher.

### BACKGROUND

Integrated circuit chips such as microprocessors often make use of different supply voltages for different parts of the chip. A main supply voltage may be provided to the chip from an off-chip source, and one or more voltage regulators may be used to convert the main supply voltage into other, typically lower, supply voltages for use by the rest of the chip. When the main supply voltage is the highest of the supply voltages used by the chip, the voltage regulators that are used to obtain the other, lower voltages are sometimes referred to as “buck” voltage regulators. Lower operating voltages can help reduce power consumption, and can enable the design of denser and faster circuits. Switching voltage regulators are often used when it is desirable to convert one voltage to another voltage with relatively high efficiency, thereby reducing heat generation and further reducing power consumption.

### BRIEF DESCRIPTION OF THE DRAWINGS

Reference will be made to the following drawings, in which:

FIG. 1 is an illustration of an embodiment of a switching voltage regulator.

FIG. 2 illustrates an output waveform of a switching voltage regulator such as that shown in FIG. 1.

FIG. 3 is a more detailed illustration of a switching voltage regulator such as that shown in FIG. 1.

FIG. 4 illustrates another output waveform associated with a switching voltage regulator such as that shown in FIG. 1.

FIG. 5 is an illustration of another embodiment of a switching voltage regulator.

FIG. 6 is an illustration of a load compensator for use in connection with a switching voltage regulator such as that shown in FIG. 5.

FIG. 7 illustrates an output waveform associated with a switching voltage regulator such as that shown in FIG. 5.

FIG. 8 illustrates a method of using a load compensator such as that shown in FIGS. 5 and 6 to reduce ringing on the output of a voltage regulator.

FIG. 9 is an illustration of a circuit that makes use of one or more voltage regulators such as those shown in FIGS. 1, 3, and 5.

### DESCRIPTION OF SPECIFIC EMBODIMENTS

Systems and methods are disclosed for performing voltage regulation. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

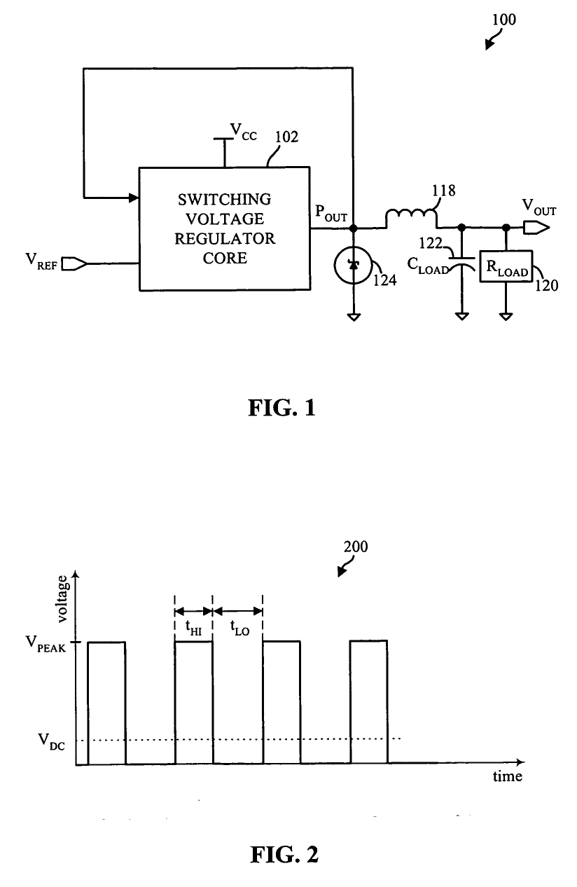

FIG. 1 illustrates a switching voltage regulator 100 that converts an input voltage (V_{CC}) to a lower output voltage V_{OUT}. Switching voltage regulator core 102 drives discrete components composed of a load 120 (R_{LOAD}), a decoupling capacitor 122 (C_{LOAD}), an inductor 118, and a Schottky diode 124, where load 120 may, for example, comprise the effective resistance of a circuit connected to the voltage regulator that is designed to make use of the lower output voltage that the voltage regulator supplies.

Voltage regulator 100 outputs a pulse train waveform at P_{OUT}. Inductor 118 and capacitor 122 form a low-pass filter that filters out the alternating current (AC) component of the pulse train, leaving the direct current (DC) component at output V_{OUT}. Schottky diode 124 prevents excessive negative spikes during P_{OUT} transitions.

FIG. 2 shows an example of a pulse train 200 such as that appearing at P_{OUT} of voltage regulator 100. As shown in FIG. 2, pulse train 200 has a DC component, V_{DC}, that is effectively equal to the average value of the pulse train. That is, the DC component is given by:

$${V}_{DC} = {V}_{PEAK} \cdot ( \frac{{t}_{HI}}{{t}_{LO} + {t}_{HI}} ) = {V}_{PEAK} \cdot Duty\_Cycle \qquad Equation 1$$

where V_{PEAK} is the peak voltage of pulse train 200, and the duty cycle is the time that pulse train 200 is at a high value divided by the period of the pulse train.

It should be appreciated that while Equation 1 and the other equations that follow refer to the equality of various quantities, the relationships described in these equations are to some degree approximations, since certain, typically insubstantial factors have been ignored (e.g., the non-zero rise time of P_{OUT} in FIG. 2, the series resistance of the wires that couple various elements in FIG. 1, and the like). Thus, use of the equals symbol (i.e., “=”) refers to substantial equality, and should not be interpreted to require exact equality of the quantities referenced in the equations.

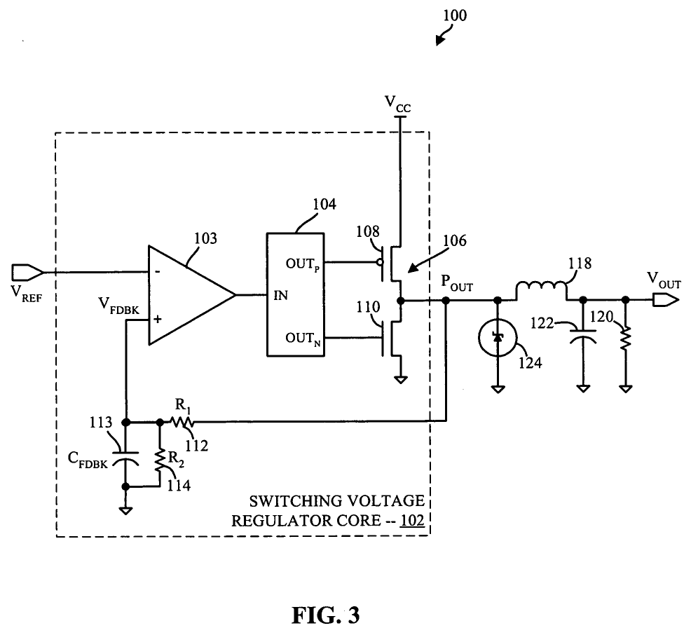

FIG. 3 provides a more detailed illustration of one possible embodiment of switching voltage regulator 100, and switching voltage regulator core 102 in particular. As shown in FIG. 3, a comparator 103, such as a differential amplifier, accepts a precision reference voltage, V_{REF}, and a feedback voltage, V_{FDBK}, and provides an output voltage that represents the amplified difference between the two inputs. In the embodiment shown in FIG. 3, the comparator output is coupled as an input to pre-driver circuit 104, the output of which is used to drive an inverting output stage 106 comprised of two field effect transistors (FETs) 108, 110. In the embodiment shown in FIG. 3, these transistors are complementary metal oxide semiconductor (CMOS) transistors, namely, a p-type metal oxide semiconductor (PMOS) transistor 108, and an n-type metal oxide semiconductor (NMOS) transistor 110. Output stage 106 produces a pulsed output voltage, P_{OUT}, that has the form of a pulse train such as that shown in FIG. 2. As shown in FIG. 3, the pulsed output voltage, P_{OUT}, is fed back to the positive input of comparator 103 via the voltage divider comprised of resistors R₁ 112 and R₂ 114, and filter capacitor 113. Switching voltage regulator core 102 thus forms part of a negative-feedback loop, where V_{FDBK} is forced to equal V_{REF}, and where, as a result, V_{OUT} is a substantially constant function of V_{REF} that can be expressed as follows:

$${V}_{OUT} = ( 1 + \frac{{R}_{1}}{{R}_{2}} ) \cdot {V}_{REF} \qquad Equation 2$$

It should be appreciated that FIGS. 1 and 3 are provided for purposes of illustration, not limitation, and that any suitable voltage regulator design could be used in connection with the systems and methods described herein. For example, in other embodiments, feedback could be taken from V_{OUT} rather than P_{OUT}.

Referring once again to FIG. 1, during steady-state operation the current flowing through inductor 118 will equal the current flowing through load 120. However, since the current flowing through an inductor cannot change suddenly, any sudden change in the load current (as might occur if R_{LOAD} were to change) will create a sudden imbalance between the current flowing through inductor 118 and the current flowing through load 120. This imbalance will be compensated for with excess current supplied—or, as the case may be, consumed—by capacitor 122. As a result, the excess current will flow back and forth between inductor 118 and capacitor 122 until the energy represented by this current is dissipated by the small series resistance present in the path through which the current flows. This back-and-forth current flow takes the form of a decaying oscillation at output V_{OUT}.

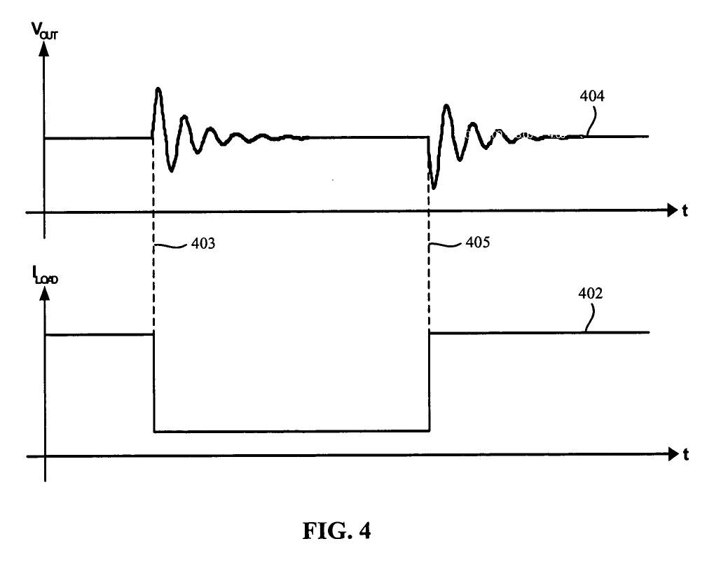

FIG. 4 illustrates how changes in load current 402 result in decaying oscillations in the output voltage, V_{OUT}, 404. As shown in FIG. 4, if, for example, load current 402 suddenly decreases (as indicated in FIG. 4 by dashed line 403), the output voltage V_{OUT} 404 will correspondingly increase as the excess inductor current charges up capacitor 122. As the voltage on capacitor 122 increases, a negative voltage develops across inductor 118, causing the current flowing through inductor 118 to decrease and, ultimately, to reverse direction and start discharging the capacitor 122. This process repeats itself until the excess energy is dissipated and the output voltage returns to its pre-imbalance steady-state DC level.

If, on the other hand, load current 402 suddenly increases (as indicated in FIG. 4 by dashed line 405), then the same effect takes place as in the case of a sudden decrease in load current 402, with the exception that the polarity of the ringing is reversed: instead of initially rising, the output voltage 404 initially falls.

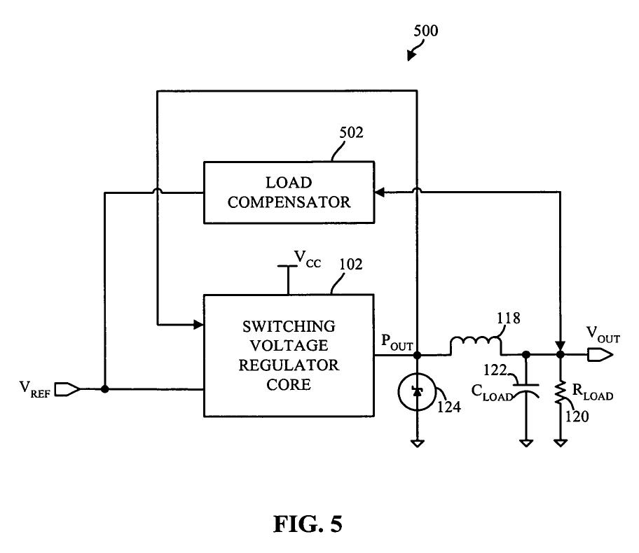

FIG. 5 shows an embodiment of a voltage regulator 500 that can be used to suppress the output ringing described above. Referring to FIG. 5, a load compensator 502 is coupled to a voltage regulator that is otherwise similar to voltage regulator 100 shown in FIG. 1. In one embodiment, load compensator 502 is a relatively simple and efficient circuit for suppressing output ringing caused by sudden changes in load current. Load compensator 502 has two terminals, an input terminal that receives the same reference voltage V_{REF} that switching voltage regulator core 102 receives, and an input/output terminal connected to the output voltage V_{OUT}.

Load compensator 502 continuously monitors V_{OUT}. As long as V_{OUT} remains within a narrow, predefined range around its steady-state DC level, load compensator 502 takes no action. However, should V_{OUT} deviate from this narrow range, as would happen when the load current suddenly changes and V_{OUT} begins ringing, load compensator 502 turns on in the direction required to quickly dissipate the excess energy flowing through inductor 118 and capacitor 122. By quickly dissipating this excess energy, prolonged high-amplitude ringing is prevented, and is instead replaced by a single low-amplitude overshoot or undershoot. After this energy is dissipated, the voltage at V_{OUT} returns to its steady-state DC level, at which point the output of load compensator 502 turns off, and load compensator 502 returns to monitoring V_{OUT}.

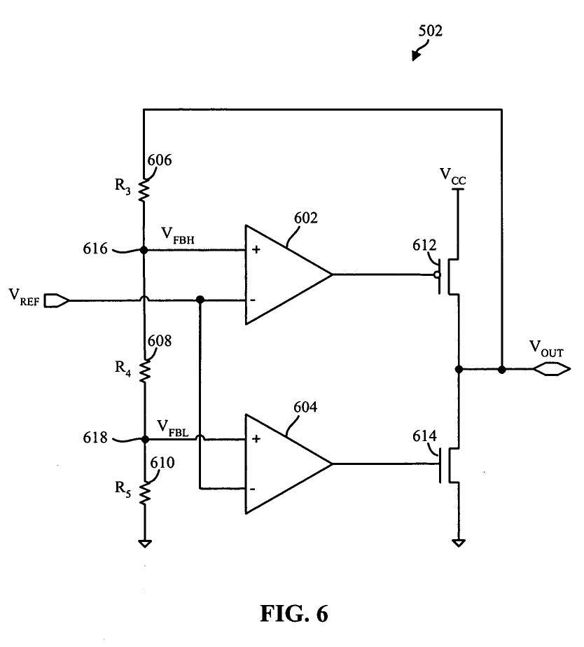

An illustrative embodiment of load compensator 502 is shown in FIG. 6. The output voltage V_{OUT} of a voltage regulator such as voltage regulator 500 in FIG. 5 is fed back through a voltage divider comprised of resistors R₃ 606, R₄ 608, and R₅ 610 to two comparators 602, 604. The resistors 606, 608, 610 in the voltage divider are chosen such that when V_{OUT} is at its steady-state DC level (i.e., when there is no ringing present on V_{OUT}) the stepped down voltage at node V_{FBH} 616 equals V_{REF}+ΔV_{H}, while the stepped down voltage at node V_{FBL} 618 equals V_{REF}−ΔV_{L}, where ΔV_{H} and ΔV_{L} define relatively small ranges over which the voltages on nodes 616 and 618, respectively, can vary without changing the state of comparators 602 and 604. Because of the voltage divider comprised of resistors 606, 608, 610, a voltage variation of ΔV_{H} at node 616 corresponds to a voltage variation at V_{OUT} of:

$$Δ {V}_{OH} = ( \frac{{R}_{3} + {R}_{4} + {R}_{5}}{{R}_{4} + {R}_{5}} ) \cdot Δ {V}_{H} \qquad Equation 3$$

Similarly, a voltage variation of ΔV_{L} at node 618 corresponds to a voltage variation at V_{OUT} of:

$$Δ {V}_{OL} = ( \frac{{R}_{3} + {R}_{4} + {R}_{5}}{{R}_{5}} ) \cdot Δ {V}_{L} \qquad Equation 4$$

Thus, ΔV_{OH} and ΔV_{OL} define a range around the steady-state DC level of V_{OUT} (i.e., V_{DCSS}) in which load compensator 502 takes no action. As long as V_{OUT} remains within this narrow range—i.e., (V_{DCSS}−ΔV_{OH})<V_{OUT}<(V_{DCSS}+ΔV_{OL})—the upper comparator 602 outputs a high voltage while the lower comparator 604 outputs a low voltage, thereby causing the two metal oxide semiconductor (MOS) transistors 612, 614 connected to the respective outputs of comparators 602 and 604 to be in cutoff, and the load compensator output to be in a high-impedance state. If, however, V_{OUT} strays above V_{DCSS}+ΔV_{OL}, the lower comparator 604 turns on NMOS transistor 614, which pulls V_{OUT} back down to its steady-state DC value. Similarly, if V_{OUT} strays below V_{DCSS}−ΔV_{OH}, the upper comparator 602 turns on PMOS transistor 612, which pulls V_{OUT} back up to its steady-state DC value.

It should be appreciated that any suitable values can be chosen for ΔV_{OH} and ΔV_{OL} through the selection of resistors 606, 608, 610. In some embodiments, ΔV_{OH} and ΔV_{OL} are chosen to be on the order of 20-50 millivolts (mV), while in other embodiments it may be desirable to use even smaller values (e.g., on the order of 10-20 mV, or even less). In some embodiments, resistors 606, 608, 610 are chosen such that ΔV_{OH} is equal to ΔV_{OL}, and the output voltage range is thus given by: (V_{DCSS}−ΔV_{OUT})<V_{OUT}<(V_{DCSS}+ΔV_{OUT}), where ΔV_{OUT}=ΔV_{OH}=ΔV_{OL}. Note that because V_{OUT} will typically be greater than V_{REF}, as described above in connection with Equation 1, it is possible to choose resistors R₃, R₄, and R₅ (and resistors R₁ and R₂ in voltage regulator core 102) such that V_{FBH} is greater than V_{REF} by the desired amount, ΔV_{H} (e.g., such that the corresponding voltage variation at V_{OUT} (i.e., ΔV_{OH}) is at a predefined value between 10 and 50 mV).

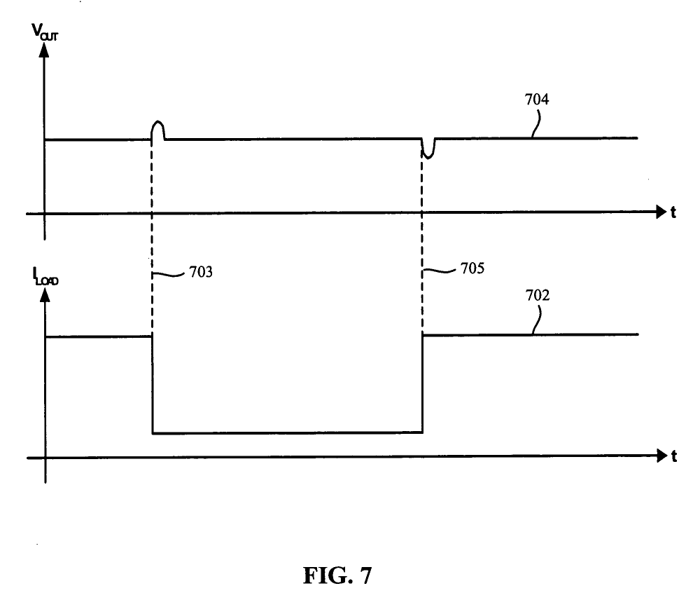

FIG. 7 shows how changes in load current 702 affect the output 704 of voltage regulator 500. When the load current 702 decreases suddenly (as indicated in FIG. 7 by dashed line 703), the voltage regulator's output 704 rises slightly, but then quickly returns to its steady state value. Similarly, when the load current 702 rises suddenly (as indicated in FIG. 7 by dashed line 705), the voltage regulator's output 704 falls slightly, but then returns to its steady state value. Thus, sudden changes in load current 702 do not produce high amplitude ringing that lasts a relatively long time. Instead, load compensator 502 reduces output ringing to a relatively small overshoot or undershoot. Thus, load compensator 502 is able to substantially suppress output ringing without requiring complex current sensing circuitry.

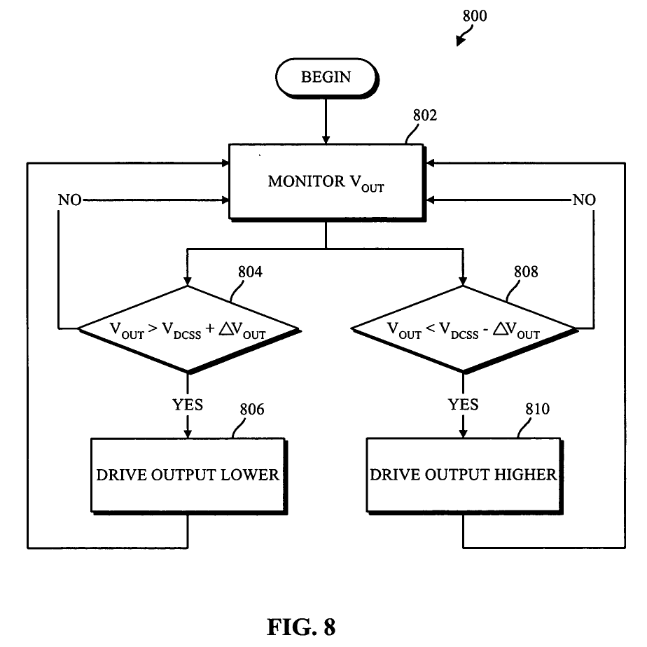

FIG. 8 is an illustration of a method of using a load compensator such as that shown in FIGS. 5 and 6 to suppress ringing on a voltage regulator output. Referring to FIG. 8, the amplitude of the output voltage is monitored (block 802), and if it exceeds a first predefined level (i.e., V_{DCSS}+ΔV_{OUT}) (block 804), the load compensator drives the output voltage lower (block 806). Similarly, if the output voltage is less than a second predefined level (i.e., V_{DCSS}−ΔV_{OUT}) (block 808), the load compensator drives the output voltage higher (block 810). Thus, the output voltage is maintained within a relatively narrow band around its steady state DC value, V_{DCSS}.

It should be appreciated that FIGS. 1-8 are provided for purposes of illustration, and not limitation, and that a number of modifications could be made without departing from the principles that are illustrated therein. For example, it should be appreciated that the various components (e.g., R₁—R₅, V_{REF}, etc.) shown in FIGS. 1-8 can be selected and implemented in any suitable manner, depending on the application at hand. Moreover, it should be appreciated that a number of other modifications could be made to the illustrative implementations shown and described in connection with FIGS. 1-8. For example, in some embodiments additional components could be added to the systems and methods illustrated and described in connection with FIGS. 1-8, and in other embodiments certain components could be removed or combined with other components. Thus, for example, while an embodiment was described above in which R₃, R₄, and R₅ were chosen to yield symmetric values of ΔV_{OH} and ΔV_{OL}, in other embodiments R₃, R₄, and R₅ could be chosen such that ΔV_{OH} does not equal ΔV_{OL}. Similarly, although FIG. 6 shows one embodiment of a load compensator 502 such as that shown in FIG. 5, load compensator 502 may comprise any suitable circuit or circuit combination that could be coupled between a voltage regulator output and a reference voltage input to offset changes in an output signal. For example, without limitation, although FIG. 6 shows the feedback voltages and the reference voltage as being coupled to the positive and negative inputs, respectively, of comparators 602 and 604, in other embodiments this polarity could be reversed, and a non-inverting output stage could be used instead of the inverting output stage shown in FIG. 6. As yet another example, in some embodiments a pulse generator could be included in the switching voltage regulator core 102 to help set the oscillation frequency of P_{OUT}, as described in commonly assigned, co-pending application Ser. No. ______, entitled “Duty Cycle Mode Switching Voltage Regulator” (Attorney Docket No. INTCP025), by Mel Bazes and concurrently filed herewith. Similarly, in some embodiments, logic gates and circuit elements such as capacitors and inductors could be replaced by their duals and/or equivalents, and the overall circuits could be modified accordingly to obtain substantially similar performance. Moreover, it should be appreciated that the voltage regulators and load compensators shown in FIGS. 1-6 can be designed and packaged in any suitable manner. For example, in some embodiments a voltage regulator may be implemented entirely on a single integrated circuit chip, while in other embodiments some or all of a voltage regulator may be implemented using discrete components, such as a separate inductor 118, capacitor 122, diode 124, output stage 106, or the like.

Thus, embodiments of the systems and methods described herein can be used for a wide variety of purposes and in a wide variety of applications. For example, embodiments of the load compensator described herein, on account of their simplicity and effectiveness, are particularly useful in implementing integrated complementary metal oxide semiconductor (CMOS) switching voltage regulators for use in microprocessors, Ethernet controller chips, or any other suitable chip or system. For example, embodiments of the systems and methods described here can be used to provide voltage regulation for laptop computers and other battery-operated applications, or other applications for which relatively low heat generation and power consumption are desirable.

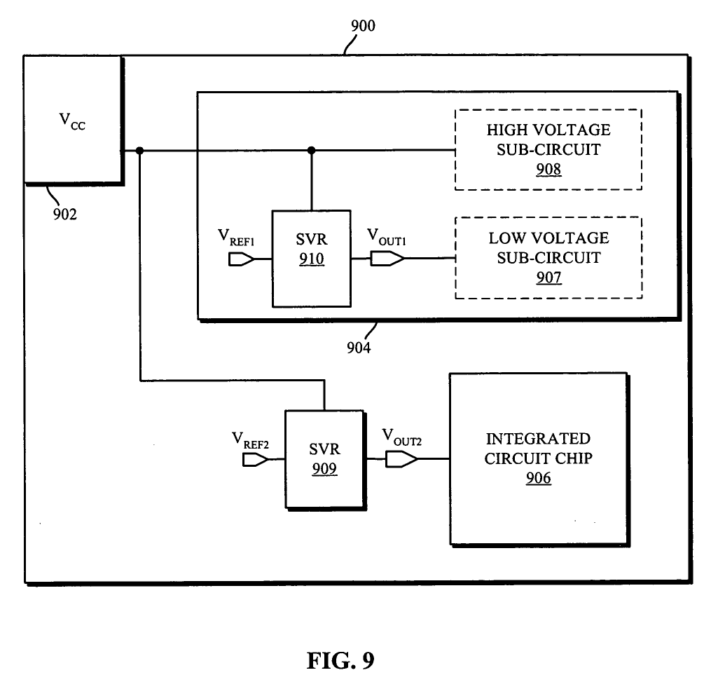

An example of one such system is shown in FIG. 9. Referring to FIG. 9, a circuit board 900 is shown that includes a power supply input, V_{CC} 902, and two integrated circuit (IC) chips 904 and 906. Chip 904 includes a voltage regulator 910, such as voltage regulator 500 in FIG. 5, that is coupled to V_{CC} 902 and generates a supply voltage V_{OUT1} that is lower than V_{CC} for use by low voltage sub-circuit 907. Chip 904 also includes a sub-circuit 908 that uses V_{CC} as its supply voltage.

Circuit board 900 further includes a voltage regulator 909, such as that shown in FIGS. 1, 3, or 5, that is manufactured as an independent integrated circuit chip or board. Voltage regulator 909 is also coupled to V_{CC}, and generates an output supply voltage V_{OUT2}, that is used by integrated circuit chip 906.

By using supply voltages V_{OUT1} and V_{OUT2} that are lower than V_{CC}, low voltage sub-circuit 907 and integrated circuit chip 906 may consume less power than if V_{CC} were used as the supply voltage.

It should be appreciated that FIG. 9 is provided for purposes of illustration, and not limitation, and that a number of variations can be made to the systems and methods described in connection therewith. For example, it should be appreciated that the elements shown in FIG. 9 can be implemented in any suitable manner, and that a number of modifications could be made to the illustrative implementations shown in FIG. 9. For example, chips 904 and 906 may include digital circuits and/or analog circuits, and circuit board 900 may be used in various systems, such as computer systems and telecommunications systems. Similarly, it will be appreciated that in some embodiments voltage regulator 910 may be manufactured on the same die as circuit 907, while in other embodiments voltage regulator 910 and circuit 907 may be manufactured on different dies but packaged in the same package. In yet another example, there may be more than one voltage regulator generating various supply voltages in the same chip, or a single voltage regulator may span, or be used by, a number of chips. In some embodiments V_{CC} 902 may be powered by an external power supply, while in other embodiments, V_{CC} 902 may be powered by an on-board power supply.

Thus, while several embodiments are described and illustrated herein, it will be appreciated that they are merely illustrative. For example, without limitation, while various embodiments of a voltage regulator have been shown in the context of actual circuit implementations, it will be appreciated that these voltage regulators could be modeled in a computer simulation system as well. Accordingly, other embodiments are within the scope of the following claims.

What is claimed is:

1. A voltage regulator comprising:
a first input operable to be coupled to a supply voltage;
a second input operable to be coupled to a reference voltage;
a voltage regulator output operable to provide an output voltage that is a substantially constant function of the reference voltage; and
a load compensator coupled between the voltage regulator output and the reference voltage, the load compensator being operable to substantially suppress ringing of the output voltage.

2. The voltage regulator of claim 1, in which the load compensator is operable to detect a variation in the output voltage, and to suppress the variation if the variation has a magnitude that exceeds a predefined amount.

3. The voltage regulator of claim 2, in which the predefined amount is between 10 mV and 50 mV.

4. The voltage regulator of claim 1, in which the load compensator comprises a first comparator, the first comparator having a first comparator input coupled to the reference voltage, and a second comparator input coupled to a feedback loop, the feedback loop being operable to provide a first voltage at the second comparator input that is a first function of the output voltage.

5. The voltage regulator of claim 4, in which the load compensator further comprises a second comparator, the second comparator having a third comparator input coupled to the reference voltage, and a fourth comparator input coupled to the feedback loop, the feedback loop being operable to provide a second voltage at the fourth comparator input that is a second function of the output voltage.

6. The voltage regulator of claim 5, further comprising:
a first transistor, the first transistor having a gate that is coupled to an output of the first comparator, the first transistor being operable to drive the voltage regulator output higher in response to the output of the first comparator.

7. The voltage regulator of claim 6, further comprising:
a second transistor, the second transistor having a gate that is coupled to an output of the second comparator, the second transistor being operable to drive the voltage regulator output lower in response to the output of the second comparator.

8. The voltage regulator of claim 1, in which the feedback loop includes a voltage divider circuit.

9. The voltage regulator of claim 1, wherein the output voltage has a steady state value that is less than the supply voltage.

10. A system comprising:
a first comparator having a reference voltage and a first stepped down version of a voltage regulator output as inputs, the first comparator being operable to drive the voltage regulator output higher if the first stepped down version of the voltage regulator output is less than the reference voltage, and
a second comparator having the reference voltage and a second stepped down version of the voltage regulator output as inputs, the second comparator being operable to drive the voltage regulator output lower if the second stepped down version of the voltage regulator output is greater than the reference voltage.

11. The system of claim 10, further comprising:
a voltage divider coupled between the voltage regulator output, an input of the first comparator, and an input of the second comparator, the voltage divider being operable to provide the first and second stepped down versions of the voltage regulator output.

12. The system of claim 10, in which steady state values of the first stepped down version of the voltage regulator output and the second stepped down version of the voltage regulator output define a range over which the voltage regulator output may vary.

13. The system of claim 10, further comprising:
a first transistor, the first transistor having a gate that is coupled to an output of the first comparator, the first transistor being operable to drive the voltage regulator output higher in response to the output of the first comparator; and
a second transistor, the second transistor having a gate that is coupled to an output of the second comparator, the second transistor being operable to drive the voltage regulator output lower in response to the output of the second comparator.

14. A method of suppressing ringing on an output of a voltage regulator, the method comprising:
using a load compensator to monitor the output of the voltage regulator;
if an output voltage is detected that is greater than a first predefined level, driving the output voltage lower; and
if an output voltage is detected that is less than a second predefined level, driving the output voltage higher.

15. The method of claim 14, in which the load compensator comprises:
a first comparator having a reference voltage and a first stepped down version of the output voltage as inputs, the first comparator being operable to drive the output voltage higher if the first stepped down version of the output voltage is less than the reference voltage, and
a second comparator having the reference voltage and a second stepped down version of the output voltage as inputs, the second comparator being operable to drive the output voltage lower if the second stepped down version of the output voltage is greater than the reference voltage.

16. The method of claim 15, further comprising:
using a voltage divider to obtain the first and second stepped down versions of the output voltage.

17. The method of claim 14, in which the first predefined level and the second predefined level define a symmetric range over which the output voltage may vary.

18. The method of claim 14, in which the first predefined level exceeds a steady state value of the output voltage by a first predefined amount between 10 mV and 50 mV, and in which the steady state value of the output voltage exceeds the second predefined level by a second predefined amount between 10 mV and 50 mV.

19. A system comprising:
a circuit board;
a first integrated circuit chip comprising:
a first circuit designed to operate using a first supply voltage;
a second circuit designed to operate using a second supply voltage; and
a first voltage regulator operable to generate the second supply voltage from the first supply voltage, the first voltage regulator comprising:
a first input operable to be coupled to the first supply voltage;
a second input operable to be coupled to a reference voltage;
a voltage regulator output operable to provide the second supply voltage, the second supply voltage being a substantially constant function of the reference voltage; and
a load compensator coupled between the voltage regulator output and the reference voltage, the load compensator being operable to substantially suppress ringing on the voltage regulator output.

20. The system of claim 19, further comprising:
a second integrated circuit chip, the second integrated circuit chip comprising a third circuit designed to operate using a third supply voltage; and
a second voltage regulator operable to generate the third supply voltage from the first supply voltage.

21. The system of claim 20, in which the second voltage regulator comprises:
a second load compensator coupled between an output of the second voltage regulator and a second reference voltage, the second load compensator being operable to substantially suppress ringing on the output of the second voltage regulator.

22. The system of claim 20, in which the second voltage regulator comprises an integrated circuit chip.
